(19) United States
(12) Patent Application Publication
(10) Pub. No.: US 2006/0144899 A1
(43) Pub. Date: Jul. 6, 2006

(54) Jam detection apparatus and method for indexing of substrates and lead frames

(76) Inventors: Xiao Ping Hu, Oreland, PA (US); Yao Ming Wang, Singapore (SG); Arindam Sinharoy, Singapore (SG); Shun Jun He, Singapore (SG); Feng Yu, Singapore (SG)

Correspondence Address: RATNERPRESTIA, P O BOX 980, VALLEY FORGE, PA, 19482-0980, US

(21) Appl. No.: 11/026,008

(22) Filed: Dec. 30, 2004

(51) Int. Cl. B23K 37/00; B23K 1/00

(52) U.S. Cl. 228/4.5; 228/102; 228/103

(57) ABSTRACT

A system for detecting jamming of at least one workpiece for use with a wire bonder comprises a sensor positioned adjacent a path of travel of the at least one workpiece, the sensor receiving motion information related to the at least one workpiece; and a controller in communication with the sensor for receiving and processing output signals from the sensor based on the motion information, the processor generating control signals based on the output signals to control movement of the at least one workpiece, wherein the controller stops movement of the at least one workpiece if the at least one workpiece becomes jammed along the path of travel.

### FIELD OF THE INVENTION

This invention relates generally to wire bonding equipment. More specifically, the present invention relates to an apparatus and process for detecting jamming of lead frames and substrates during ejection from a wirebonder.

### BACKGROUND OF THE INVENTION

Modern electronic equipment relies heavily on printed circuit boards on which semiconductor chips, or integrated circuits (ICs), are mounted. The mechanical and electrical connections between the chip and the substrate have posed challenges for chip designers.

The most common of these processes is wire bonding. In wire bonding, a plurality of bonding pads are located in a pattern on the top surface of the substrate, with the chip mounted in the center of the pattern of bonding pads, with the top surface of the chip facing away from the top surface of the substrate. Fine wires (e.g., aluminum, copper, or gold wires) are connected between the contacts on the top surface of the chip and the contacts on the top surface of the substrate.

Chip scale packages (CSPs) offer a solution to the challenge of shrinking the size of semiconductor devices relative to the size of the chip (die) contained in the package. Typically, the CSP size is between 1 and 1.2 times the perimeter size of the die, or 1.5 times the area of the die. The CSP offers a compact size near that of a bare die or flip chip technology, and offers greater reliability, because the CSP need not suffer from the same thermal expansion incompatibility problems which are known in flip chips.

Most CSPs use a flexible, sheetlike interposer (e.g., a polyimide film or tape), having fine, flexible wiring embedded therein. The fine wirings in the interposer end at peripheral terminals near the periphery of the chip when the chip is mounted on the interposer. An example is the Micro Ball Grid Array (Micro BGA) design. The wirings redistribute the peripheral terminals of the interposer to a grid array of solder ball lands that cover the interior area of the chip. The chip is mounted on the interposer, and the plurality of terminals in the interposer are bonded to the plurality of contacts on the periphery of the chip using a conventional bonding technique, such as ultrasonic (wedge) bonding. Once the device is wire bonded it is ejected into an output magazine for further processing.

There is a drawback, however, in that because the substrates and/or lead frame are heated during the bonding process there is a tendency for the devices to jam and crumple during ejection from the wire bonder into the output magazine. Conventional detection systems using contact type sensors do not detect these jams until significant damage has occurred to the lead frame and/or substrate. Also, conventional gripper systems that are used to eject the lead frames and/or substrates do not adjust their gripping force as the devices are moved through the zone where crumpling can occur (“the crumple zone”). Accordingly, there is a need for a system that detects crumpling before significant damage is done to the newly bonded devices as well as a system where the gripping force on the devices is adjusted as the devices move through the crumple zone.

### SUMMARY OF THE INVENTION

In view of the shortcomings of the prior art the present invention is a system and method for detecting jamming of at least one workpiece for use with a wire bonder.

The apparatus comprises a sensor positioned adjacent a path of travel of the at least one workpiece, the sensor receiving motion information from the at least one workpiece; and a controller coupled to the sensor for receiving and processing output signals from the sensor based on the motion information, the processor generating control signals based on the output signals to control movement of the at least one workpiece, wherein the controller stops movement of the at least one workpiece if the at least one workpiece becomes jammed along the path of travel.

According to another aspect of the invention, the apparatus also includes a gripper electrically coupled to the controller. The gripper imparts motion to the at least one workpiece along the path of travel based on the control signals from the controller.

According to a further aspect of the present invention, the gripper is detachably coupled to a portion of the at least one workpiece with a predetermined force based on a position of said at least one workpiece along the path of travel.

According to a yet another aspect of the present invention, the predetermined force is reduced if the at least one workpiece is within a predetermined portion of the path of travel.

According to a still another aspect of the present invention, the gripper is uncoupled from the workpiece if the controller determines that the at least one workpiece is jammed along the path of travel.

According to a further aspect of the present invention, the sensor is an optical sensor disposed either above the path of travel or on a side of the path of travel.

According to another aspect of the present invention, the output signal from the optical sensor has a predetermined periodicity.

According to yet another aspect of the present invention, a jam of the at least one workpiece is indicated based on a change in the predetermined periodicity of the output signal.

In certain exemplary embodiments, the method comprises the steps of imparting motion to the at least one workpiece along a path of travel in the bonding machine; monitoring motion of the at least one workpiece along the path of travel; generating output signals based on the monitoring step; determining a signal profile of the output signals; and discontinuing further motion of the at least one workpiece based on a change in the signal profile.

According to another aspect of the invention, the method also comprises the steps of reducing a predetermined gripping force on the at least one workpiece when the at least one workpiece is within a predetermined section of the path of travel; and removing the gripping force from the at least one workpiece if the at least one workpiece becomes jammed based on this determination.

### BRIEF DESCRIPTION OF THE DRAWINGS

The invention is best understood from the following detailed description when read in connection with the accompanying drawings. It is emphasized that, according to common practice, various features of the drawings are not to scale. On the contrary, the dimensions of various features are arbitrarily expanded or reduced for clarity. Included in the drawings are the following Figures:

FIG. 1 is a block diagram of an exemplary embodiment of the present invention;

FIG. 2 is an exemplary output signal produced by the exemplary embodiment of FIG. 1;

FIGS. 3A-3B are perspective views of exemplary approaches to mounting the inventive system; and

FIGS. 4A-4B and 5A-5B are exemplary output and response signals according to the exemplary embodiment of FIG. 1.

### DETAILED DESCRIPTION OF THE INVENTION

As used herein, the term “jammed” refers to any unintended state of motion of a workpiece along a path of travel of the workpiece. For example, based on the particular application, such states may include (a) stoppage of motion of the workpiece, (b) an unintended reduction or increase in the speed of motion of the workpiece, and/or (c) movement of the workpiece outside of a predetermined area along the path of travel. The jamming of the workpiece may occur, for example, through unintended contact of the workpiece with a structure during travel of the workpiece, and/or unintended or defective operation of the system causing the motion of the workpiece.

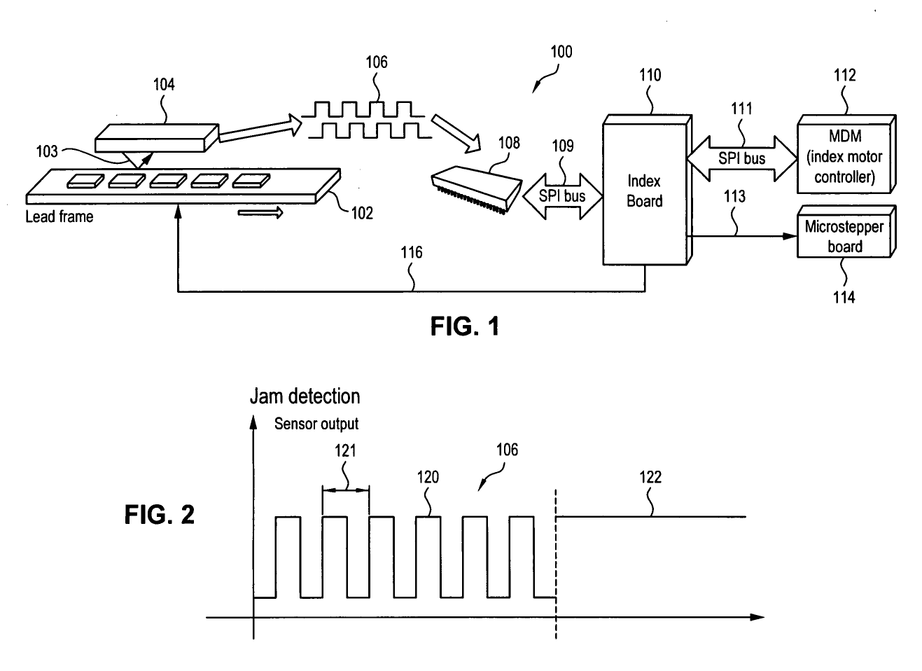

Referring now to FIG. 1, a block diagram of an exemplary embodiment of the present invention is illustrated. As shown in FIG. 1, system 100 comprises detector 104, such as an optical detector model number ADNS-2051 manufactured by Agilent Technologies of Palo Alto Calif., coupled to processor 108, which is in turn coupled to indexer board 110 via a communication channel 104, such as an SPI bus. Indexer board 110 is desirably coupled to (1) indexer motor controller 112 (for example via communication channel 111, such as an SPI bus), (2) microstepper board 114 (via control line 113), and (3) a gripper (not shown) (via control line 116). The gripper is used to hold and move (drag and/or push) workpiece 102 along a conveyor system (not shown) though the bonding process. Communication channels 104 and 111 may be the same communication channel or may be separate communication channels based on design considerations.

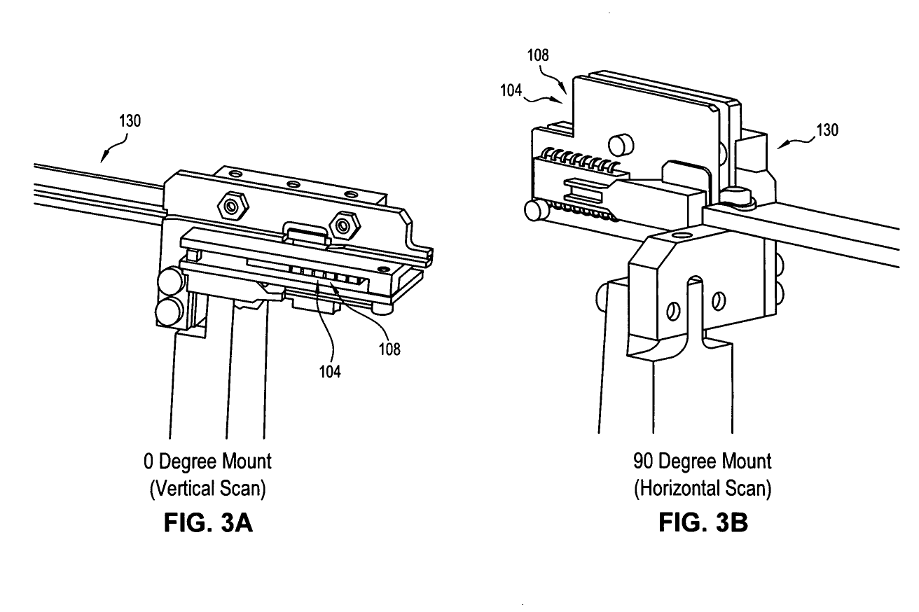

In operation, detector 104 generates output signal 106 (best shown in FIG. 2) in response to optical stimulus 103 received from a surface of workpiece 102. Output signal 106, which has a pulse width based on the velocity that workpiece 102 moves along the system, is provided to processor 108. In one exemplary embodiment, it is contemplated that the speed at which workpiece 102 proceeds through the system will be substantially constant and less than about 10 inches/second. According to the present invention, output signal 106 is not limited to being a quadrature signal (i.e., as shown in FIG. 1), and may be any of a number of appropriate signals, for example, a single periodic output signal.

Processor 108 analyses output signal 106 and provides commands via communication channel 104 to control movement of workpiece 102 in the system. In an exemplary embodiment of the present invention, this analysis is a comparison of output signal 106 with a predetermined threshold value. An exemplary threshold value is about 16 milliseconds. In another exemplary embodiment of the present invention, this analysis is a comparison of output signal 106 with a real-time speed signal (e.g., communicated by the motor controller), thus allowing the detection of a jam during non-steady-state motion (i.e., acceleration or deceleration).

As shown in FIG. 2, in normal operation, as workpiece 102 proceeds along in the process, output signal 106 has a pulsed profile 120, for example, that has a periodicity 121 based on the speed of workpiece 102. If, during the process, the movement of workpiece 102 is negatively effected, such as by jamming during ejection for example, the profile of the output signal will change. In the example presented, the profile of output signal 106 becomes steady state at a digital “1” state. It is also contemplated that the output signal may become a digital “0” steady state during a jamming condition of workpiece 102. Further still, other changes to the signal profile (e.g., in connection with a threshold value) may also be used in accordance with the present invention. In any event, this information (i.e., the change in the profile of the output signal) is provided by processor 108 to indexer board 110 via communication bus 104.

If indexer board 110 receives information from processor 108 indicating a jam of workpiece 102, indexer board 110 will desirably halt further movement of workpiece 102 by commanding the gripper (not shown) to release its hold on workpiece 102. Alternatively, and/or additionally, indexer board may also command the motor (not shown) used to move the gripper to halt via communication channels 111 and/or 113. It is also contemplated that an alarm signal (not shown) will be generated to advise the operator of the failure condition so that remedial measures may be taken to correct the problem.

In one exemplary embodiment, a force exerted by the gripper may also be controlled by indexer board 110 based on where in the process the workpiece currently is positioned. For example, in certain situations where the workpiece is in motion (e.g., outside of the jam window) the force on the gripper may be set to a high level to ensure that the workpiece remains stationary to achieve higher accelerations. Another example relates to bonding of the workpiece, where the gripper is desirably completely disengaged from the workpiece.

As the workpiece is being ejected after bonding, the workpiece is detected by detector 104 as entering the ejection stage (i.e., the jam window) of the process. Upon such recognition, detector 104 provides output signal 106 to processor 108. Processor 108 in turn desirably reduces the force exerted by the gripper on workpiece 102 via control line 116. In this way, if workpiece 102 does become jammed during ejection, the coupling between workpiece 102 and the gripper may slip, thereby reducing damage to workpiece 102. This feature may be used in conjunction with, or as an alternative to, the feature described above in which the motion of workpiece 102 is halted when a jam is detected.

Although entry into the ejection stage of the process is described above in connection with physical detection of the workpiece position by detector 104, other methods of detecting entry into the ejection stage are contemplated. For example, a sensor which provides a “present” or “not present” signal corresponding to the location of the workpiece may be used. Further, entry into the ejection stage may be detected by software using (1) a known initial position of the workpiece, and (2) data provided by a motor controller used to move the workpiece (e.g., time elapsed during motion, speed, etc.).

Sensors used to detect motion and/or position of the workpiece may be of any of a number of types of appropriate sensing mechanisms including optical sensors and roller sensors. For example, a roller sensor may include a rotary encoder used in connection with a contact mechanism (e.g., a contact “wheel” that rotates along with motion of the workpiece) for contacting the workpiece.

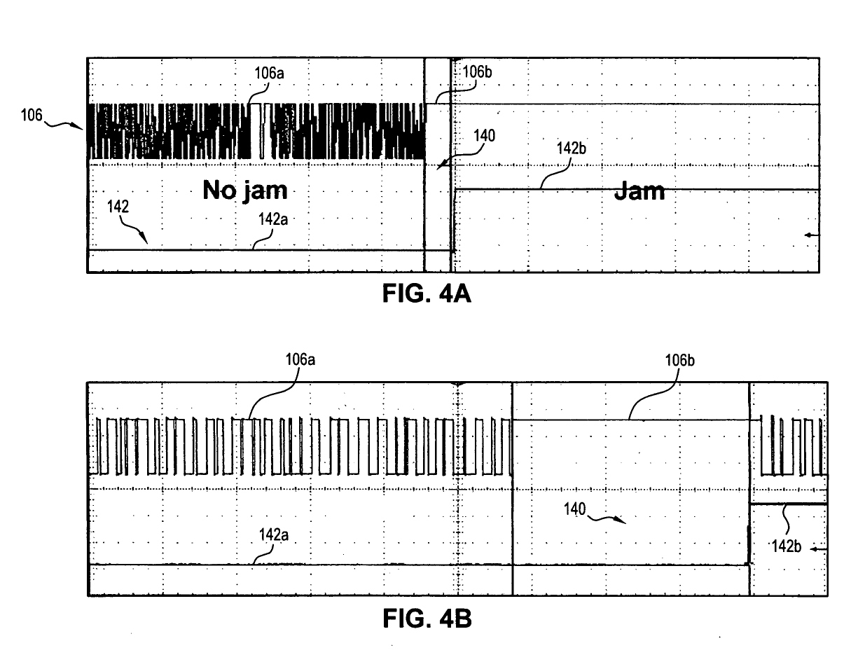

Referring now to FIGS. 3A-3B, exemplary mounting approaches are illustrated. As shown in FIG. 3A, at least a portion of system 100, such as detector 104 and processor 108, is mounted above a travel path of workpiece 102 (not shown in this figure) and adjacent rear rail 130 of the conveyor system. This type of mounting may be beneficial when dealing with thin copper lead frames for example. Alternatively, and as shown in FIG. 3B, at least a portion of system 100, such as detector 104 and processor 108, is mounted along side a travel path of workpiece 102 (not shown in this figure) and adjacent rear rail 130 of the conveyor system. This type of mounting may be beneficial when dealing with Ball Grid Array (BGA) devices for example.

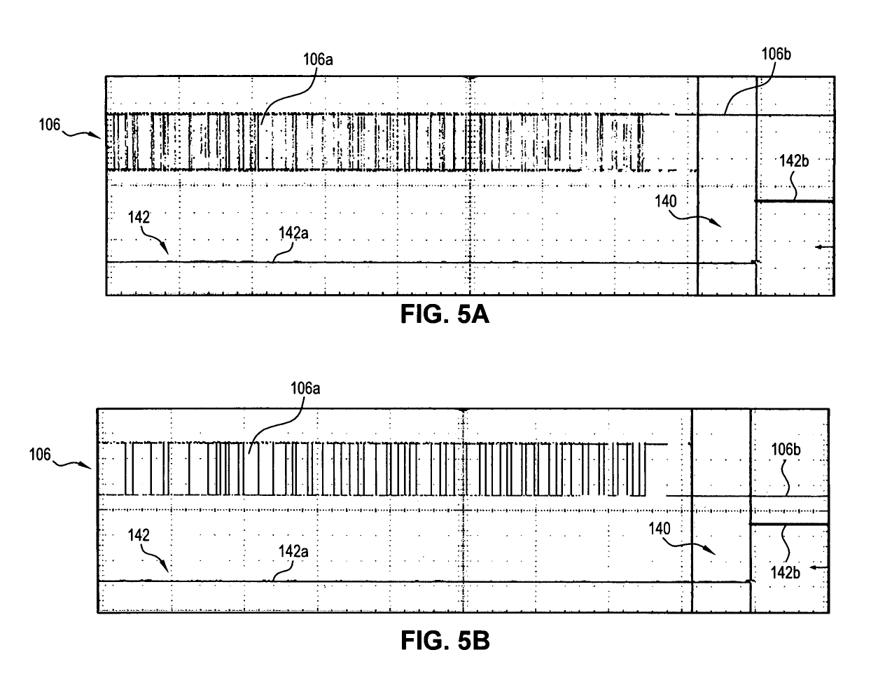

Referring now to FIGS. 4A-4B, exemplary signal diagrams are illustrated for the embodiment of FIG. 3A. As shown in FIG. 4A, for an exemplary 8 mil thick copper lead frame, during normal operation output signal 106 has a pulsed profile 106a. Accordingly, jam signal 142 has a “0” or “normal condition” output in response. Upon detection of a jam, the profile of output signal 106 changes from that of pulse 106a to steady state 106b. In order to avoid false triggering of an alarm condition and subsequent unintended stoppage of the process, it is desirable to include a threshold time after which a true failure is indicated. This threshold or window is indicated as 140 in FIG. 4A. In an exemplary embodiment, threshold 140 is about 16 mSec for reliable jam detection. If after the threshold period 140 is exceeded and the profile of signal 106 is still a steady state, the condition of jam signal 142 changes to 142b as illustrated, which is indicative of a jam. Accordingly, and as described above, the movement of workpiece 102 is halted and/or the grip on device 102 is released. FIG. 4B is similar to FIG. 4A except that the horizontal scale of the display is changed and that the workpiece under test is a 4 mil thick silver lead frame.

Referring now to FIGS. 5A-5B, exemplary signal diagrams are illustrated for the embodiment of FIG. 3B. As shown in FIG. 5A, during normal operation, output signal 106 has a pulsed profile 106a. Accordingly, jam signal 142 has a “0” or “normal condition” output in response. Upon detection of a jam, the profile of output signal 106 changes from that of pulse 106a to steady state 106b. In order to avoid false triggering of an alarm condition and subsequent stoppage of the process, it is desirable to include a threshold time after which a true failure is indicated. This threshold or window is indicated as 140 in FIG. 5B. FIG. 5B is similar to FIG. 5A except that the workpiece under test is a 13 mil thick BGA substrate, whereas FIG. 5A illustrates a pulse profile for a 20 mil thick BGA substrate.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for detecting jamming of at least one workpiece for use with a wire bonder, the system comprising:
a sensor positioned adjacent a path of travel of said at least one workpiece, said sensor receiving motion information related to said at least one workpiece; and
a controller in communication with said sensor for receiving and processing output signals from said sensor based on said motion information, said processor generating control signals based on said output signals to control movement of said at least one workpiece,
wherein said controller stops movement of said at least one workpiece if said at least one workpiece becomes jammed along said path of travel.

2. The system according to claim 1, further comprising:
a gripper electrically coupled to said controller, said gripper imparting motion to said at least one workpiece along said path of travel based on said control signals from said controller.

3. The system according to claim 2, wherein said gripper is detachably coupled to a portion of said at least one workpiece with a predetermined force based on a position of said at least one workpiece along said path of travel.

4. The system according to claim 3, wherein said predetermined force is reduced if said at least one workpiece is within a predetermined portion of said path of travel.

5. The system according to claim 3, wherein said gripper is uncoupled from said workpiece if said controller determines that said at least one workpiece is jammed along said path of travel.

6. The system according to claim 1, wherein said sensor is an optical sensor disposed above said path of travel.

7. The system according to claim 1, wherein said sensor is an optical sensor disposed on a side of said path of travel.

8. The system according to claim 1, wherein said output signal from said optical sensor has a predetermined periodicity.

9. The system according to claim 8, wherein a jam of said at least workpiece is indicated based on a change in said predetermined periodicity.

10. A method for detecting jamming of at least one workpiece for use with a wire bonder, the method comprising the steps of:
imparting motion to said at least one workpiece along a path of travel in said bonding machine;
monitoring motion of said at least one workpiece along said path of travel;
generating output signals based on said monitoring step;
determining a signal profile of said output signals; and
discontinuing further motion of said at least one workpiece based on a predetermined change in said signal profile.

11. The method according to claim 10, wherein said monitoring step comprises obtaining an optical signal from at least a portion of a surface of said workpiece; and said generating step comprises generating an output signal having a predetermined periodicity based on said motion of said at least one workpiece.

12. The method according to claim 10, wherein said imparting motion step comprises the steps of:
gripping at least a portion of said at least one workpiece with a predetermined force; and
moving said at least one workpiece along said path of motion in a substantially linear direction.

13. The method according to claim 12, further comprising the steps of:
reducing said predetermined force when said at least one workpiece is within a predetermined section of said path of travel; and
removing said gripping force from said at least one workpiece if said at least one workpiece becomes jammed based on said determining step.

14. A system for detecting jamming of at least one workpiece for use with a bonding system having a gripper, the system comprising:
a sensor positioned adjacent a path of travel of said at least one workpiece, said sensor receiving motion information related to said at least one workpiece; and
a controller in communication with said sensor for receiving and processing output signals from said sensor based on said motion information, said processor generating control signals based on said output signals to control movement of said at least one workpiece,
wherein said controller at least one of i) stops movement of said at least one workpiece or ii) releases a grip of said gripper on said workpiece if said at least one workpiece becomes jammed along said path of travel.

15. The system of claim 14
wherein said controller determines if said at least one workpiece becomes jammed based on a predetermined change in a periodicity of said output signals.
